(19) United States
(12) Patent Application Publication
(10) Pub. No.: US 2006/0023582 A1
(43) Pub. Date: Feb. 2, 2006

(54) Optical pickup device and optical disk device

(75) Inventor: Sumitaka Maruyama, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/192,403

(22) Filed: Jul. 29, 2005

(30) Foreign Application Priority Data
Jul. 29, 2004 (JP) 2004-222148

(51) Int. Cl. G11B 7/00

(52) U.S. Cl. 369/44.37; 369/112.01; 369/44.41

(57) ABSTRACT

An optical pickup device has first emitting section emits first laser light, second emitting section emits second laser light, objective lens focuses first and second laser lights and emits focused laser lights to information storage medium, splitter section receives reflection lights of first and second laser lights and splits lights, light receiving section receives each of reflection lights of first and second laser lights and outputs detection signal, differential calculating section obtains differential signal between detection signals and outputs tilt signal indicating tilt of information recording medium on basis of differential signal, and correcting section corrects tilt of information recording medium with respect to emission direction of at least one of first and second laser lights on basis of tilt signal.

### CROSS-REFERENCE TO RELATED APPLICATIONS

This application is based upon and claims the benefit of priority from prior Japanese Patent Application No. 2004-222148, filed Jul. 29, 2004, the entire contents of which are incorporated herein by reference.

### BACKGROUND OF THE INVENTION

1. Field of the Invention

The present invention relates to an optical pickup device and an optical disk device which emit a plurality of laser lights and handle plural types of information recording media, and more particularly, to an optical pickup device and an optical disk device which make a tilt control based on a reflection light of each laser light.

2. Description of the Related Art

Recently, an optical disk recording and reproducing apparatus using an optical disk has been widely prevalent. As recording information becomes higher in density and more diversified, one optical disk recording and reproducing apparatus which handles plural types of information recording media is becoming more popular. On the other hand, in such an optical disk recording and reproducing apparatus which is compatible with several types of information recording media, a plurality of laser light sources are used, and a technique of utilizing the plurality of laser light sources for tilt detection is known.

In Patent Document 1 (Jpn. Pat. Appln. KOKAI Publication No. 2000-76679), there is disclosed a technique of carrying out tilt detection by using a laser light which is not used for reproduction in an optical disk device for reproducing a compact disc (CD) and a digital versatile disc (DVD) by means of one optical pickup.

In Patent Document 1, however, a tilt quantity is detected on the basis of a light quantity difference in the right and left of a detection signal in a detector element of one laser light source. Thus, in the case where a track offset or the like is included in the detection signal, the detection signal is influenced by this track offset. Therefore, there is a problem that a precise tilt quantity cannot be detected.

### BRIEF SUMMARY OF THE INVENTION

An embodiment of the present invention is an optical pickup device comprising: a first emitting section which emits a first laser light; a second emitting section which emits a second laser light that is different from the first laser light; an objective lens which focuses the first and second laser lights emitted from the first and second emitting sections and emits the focused laser lights to an information storage medium; a splitter section which receives reflection lights of the first and second laser lights from the information recording medium and splits the lights; a light receiving section which receives the reflection lights of the first and second laser lights from the splitter section and outputs a detection signal in response to each of the reflection lights; a differential calculating section which obtains a differential signal between detection signals according to the reflection lights from the light receiving section and outputs a tilt signal indicating a tilt of the information recording medium on the basis of the obtained differential signal; and a correcting section which corrects a tilt of the information recording medium with respect to an emission direction of at least one of the first and second laser lights on the basis of the tilt signal outputted from the differential calculating section.

### BRIEF DESCRIPTION OF THE SEVERAL VIEWS OF THE DRAWING

FIG. 1 is an illustrative diagram showing an example of an optical pickup device according to one embodiment of the present invention;

FIG. 2 is a graph depicting waveforms of push-pull signals caused by a first laser light and a second laser light when a tilt value of the optical pickup device according to one embodiment of the invention is zero;

FIG. 3 is a graph depicting waveforms of push-pull signals caused by a first laser light and a second laser light when a tilt value of the optical pickup device according to one embodiment of the invention is −0.2;

FIG. 4 is a graph depicting waveforms of push-pull signals caused by a first laser light and a second laser light when a tilt value of the optical pickup device according to one embodiment of the invention is +0.2;

FIG. 5 is a graph depicting a relationship between a differential signal between the push-pull signals caused by the first laser light and the second laser light and a tilt value, in the optical pickup device according to one embodiment of the invention;

FIG. 6 is an illustrative diagram showing another example of the optical pickup device according to one embodiment of the invention; and

FIG. 7 is a block diagram depicting an example of a configuration of an optical disk device using the optical pickup device according to one embodiment of the invention.

### DETAILED DESCRIPTION OF THE INVENTION

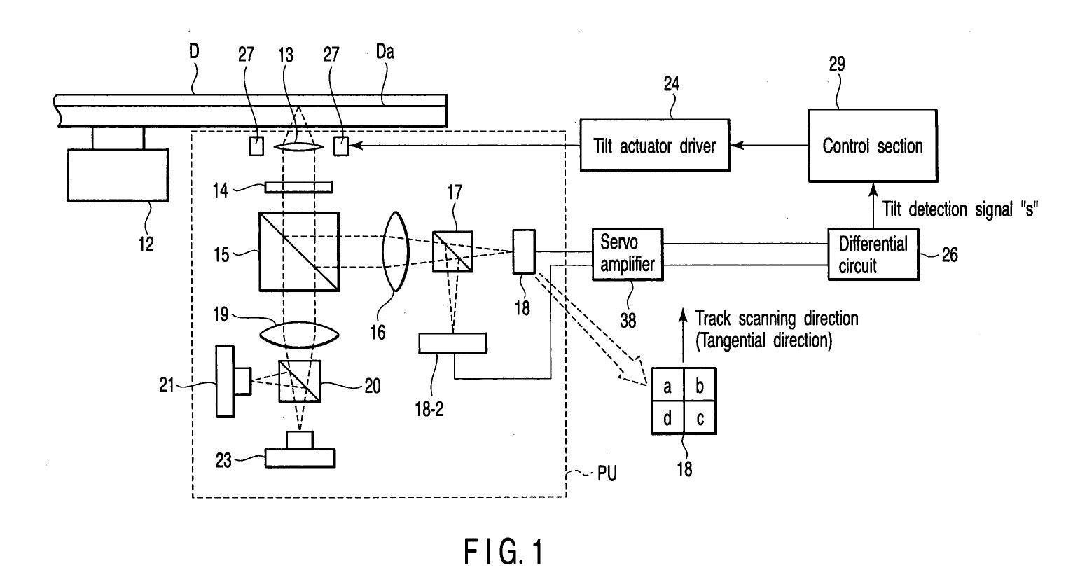

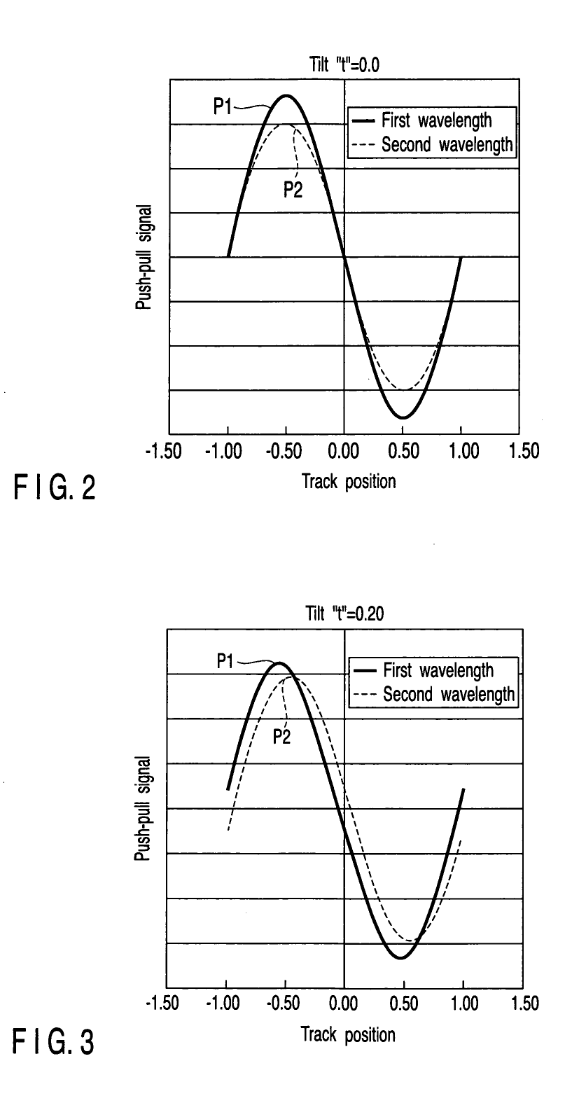

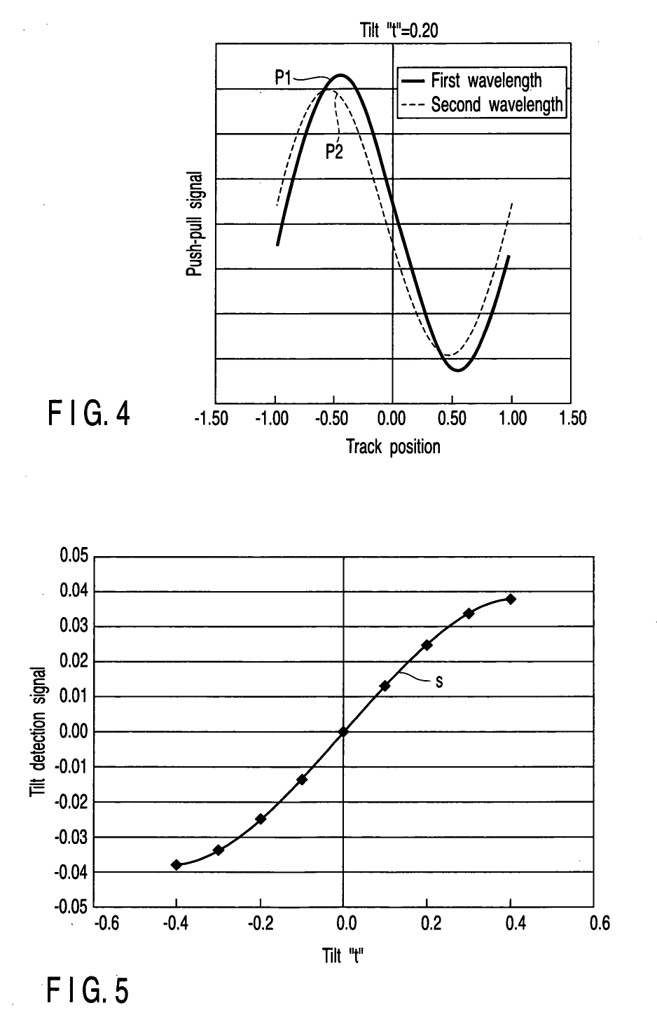

Hereinafter, one embodiment of an optical pickup device according to the invention and an optical disk device to which the optical pickup device is applied will be described in detail with reference to the accompanying drawings. FIG. 1 is an illustrative diagram showing an example of an optical pickup device according to one embodiment of the invention. FIG. 2 is a graph depicting waveforms of push-pull signals caused by a first laser light and a second laser light when a tilt value of the optical pickup device according to the embodiment of the invention is zero. FIG. 3 is a graph depicting waveforms of push-pull signals caused by a first laser light and a second laser light when a tilt value of the optical pickup device according to the embodiment of the invention is −0.2. FIG. 4 is a graph depicting waveforms of push-pull signals caused by a first laser light and a second laser light when a tilt value of the optical pickup device according to one embodiment of the invention is +0.2. FIG. 5 is a graph depicting a relationship between a tilt detection signal “s” and a tilt value “t”, the tilt detection signal being a differential signal between the push-pull signals caused by the first laser light and the second laser light, in the optical pickup device according to one embodiment of the invention.

<Optical Pickup Device>

Hereinafter, an optical pickup device mainly for use in an optical disk device according to the invention will be described in detail with reference to the accompanying drawings.

While the present embodiment describes a phase change type optical disk, it can be widely applied to an optical pickup for information storage medium having a light transmission layer. An information storage medium targeted for recording and reproduction may be a reproduction only disk, a magneto-optical disk, an optical card or the like.

An optical pickup device PU according to the invention has an information storage medium such as an optical disk D and a spindle motor 12 which rotates the medium, as shown in FIG. 1. The spindle motor rotates the information storage medium in a predetermined rotation frequency. Further, the optical disk D to/from which the pickup head PU record/reproduce information has a light transmission layer in order to protect a face “Da” of a recording and reproducing layer.

In addition, a description will be given with respect to a case in which the optical pickup device PU has two (or three) light sources with their different wavelengths. This description also applies to a case in which the optical pickup device has four or more light sources with their different wavelengths. The optical pickup device PU has a light source 23 (first wavelength) and a light source 21 (second wavelength) which have their different wavelengths. While one embodiment of each of the light sources can presume that the first wavelength is in proximity to 405 nm (high density DVD) and the second wavelength is in proximity to 660 nm (DVD), without being limited thereto. Furthermore, in the optical pickup device PU, laser lights emitted from the optical pickup device are combined with each other on a substantially identical optical axis by means of a dichroic prism 20.

Still further, in the optical pickup device PU, the laser lights are changed to parallel lights by a collimator lens 19. The parallel lights are focused by an objective lens 13 through a polarizing beam splitter 15 and a λ/4 plate 14, and the focused lights are incident to the rotating optical disk D by means of the spindle motor 12. The lights incident from a surface of the optical disk are focused on a recording and reproducing layer face “Da”. Conversely, the lights reflected on the recording and reproducing layer face “Da” are reflected by the polarizing beam splitter 15 after they have passed through the objective lens 13 and λ/4 plate 14. The reflected lights are focused on a focusing lens 16, and then, a wavelength of the reflected lights is identified by a wave face converter section 17 having wavelength selectivity, an optical axis error of two reflection waves is corrected, and light is received on, for example, an optical detector 18. One example of a specific configuration of the wave face converter section 17 is a dichroic prism 17 having wavelength selectivity with respect to only a specific wavelength. Light is divided into two lights by the dichroic prism 17 in response to each of plural types of wavelengths, and lights having their different wavelengths are received by an optical detector 18 and an optical detector 18-2, respectively. In the present embodiment, the first wavelength is assumed to be shorter than the second wavelength.

In addition, the objective lens 13 has a tilt actuator 27 for correcting a tilt of the objective lens. The objective lens also has a tracking actuator which is a drive mechanism in a tracking direction and a focus actuator which is a drive mechanism in an axial direction, which are not shown in the figure.

Furthermore, the optical pickup device PU shown in FIG. 1 has a servo amplifier 38, a differential circuit 26, and a control section 29. The servo amplifier 38 receives detection signals from the optical detector 18 and the optical detector 18-2 of the optical pickup unit PU and outputs a push-pull signal in response to each of the detection signals (the servo amplifier also outputs a tracking error signal for the tracking actuator (not shown), and a focus error signal for the focus actuator (not shown)). The differential circuit 26 receives push-pull signals according to two laser lights from the servo amplifier 38, respectively, and supplies a differential signal between the push-pull signals as a tilt detection signal “s” to a control section 29. The control section 29 receives the tilt detection signal “s”, generates a control signal considering the tilt detection signal “s”, and supplies the generated control signal to a tilt actuator driver 24.

(Tilt Correcting Process)

Now, a tilt correcting process according to one embodiment of the invention will be described in the above-described optical pickup device. The detection signals according to the respective laser lights received by the optical detector 18 and optical detector 18-2 are outputted. The detection signals are supplied to the servo amplifier 38, and from the servo amplifier 38, push-pull signals P1, P2 are outputted. Here, each of the push-pull signals P1, P2 depicts a trajectory as depicted in a graph of FIG. 2.

The push-pull signals P1, P2 are obtained in accordance with a computing process of P1=(a+d)−(b+c) with respect to a detection signal from a 4-dividing element of the optical detector 18 shown in FIG. 1, and a tilt in a radial direction can be detected.

On the other hand, a computing process of (a+b)−(c+d) is carried out in response to the detection signal from the four-dividing element, whereby a tilt in a tangential direction can be detected as a tangential push-pull signal.

In accordance with one embodiment, the (radial) push-pull signals P1, P2 for detecting the tilt in the radial direction are utilized as tilt signals for tilt control. However, in accordance with another embodiment, both of the radial push-pull signal and the tangential push-pull signal are detected, a differential signal between the detected push-pull signals is obtained, and tilt detection signals are outputted, respectively, thereby making it possible to carry out tilt control of both of the tilt in the radial direction and the tilt in the tangential direction at the same time by means of the tilt actuator 27.

Furthermore, in the case where the tilt in the tangential direction is dominant, it is also possible to obtain a differential signal and make a tilt control by utilizing only a tangential push-pull signal without the radial push-pull signals P1, P2.

In FIG. 2, the horizontal axis indicates that the positions in the radial direction (direction vertical to a signal tracing direction) are normalized in track pitches, and the vertical axis indicates amplitude values of the push-pull signals P1, P2. A zero point of the horizontal axis indicates a position at which a track offset is zero.

Here, FIG. 2 shows the values of the push-pull signals P1, P2 when a disk tilt is 0 degree. The values of the push-pull signals P1, P2 having the first and second wavelengths are zero at a zero point at which the track position on the horizontal axis is a zero point.

On the other hand, FIGS. 3 and 4 show trajectories of the push-pull signals P1, P2 in the case where disk tilts are +0.2 degree and −0.2 degree. In FIG. 3, in the case where the horizontal axis is zero, the push-pull signal P1 having the first wavelength indicates a negative value, whereas the push-pull signal P2 having the second wavelength indicates a positive value.

In FIG. 4, conversely, in the case where the horizontal axis is zero, the push-pull signal P1 having the first wavelength indicates a positive value, whereas the push-pull signal P2 having the second wavelength indicates a negative value.

As described above, a change of a push-pull signal when a tilt angle changes indicates opposing characteristics between the push-pull signal P1 having the first wavelength and the push-pull signal P2 having the second wavelength. Thus, by making a differential computation, a tilt detection signal “s” having a trajectory as shown in FIG. 5 can be obtained.

In FIG. 5, the horizontal axis indicates a tilt “t” which represents a tilt of the optical disk, and the vertical axis indicates a value of a tilt detection signal “s” obtained by a differential process executed by the differential circuit 26 having received the push-pull signal P1 caused by the detection signal according to the laser light having the first wavelength and the push-pull signal P2 caused by the detection signal according to the laser light having the second wavelength. Referring to the graph of FIG. 5, it is found that the tilt detection signal “s” uniquely changes in response to a change of the tilt “t”. By using this relationship, it becomes possible to detect a tilt of the optical disk from the push-pull signals P1, P2 of a plurality of laser lights.

In general, if the objective lens is shifted, the push-pull signals P1, P2 each include an offset. That is, in a single push-pull signal, an offset directly effects on a tilt signal. In the embodiment according to the invention, however, a changing direction of a push-pull signal due to a track offset associated with the objective lens is identical to another one, whereas the tilt detection signal “s” is a signal obtained by a differential computation. Thus, the track offset is eliminated, and the tilt detection signal is not influenced by the track offset due to the object lens shift.

Therefore, the differential circuit 26 carries out a computing process for a differential signal between the push-pull signals P1 and P2 of a plurality of laser lights, outputs the differential signal as the tilt detection signal “s”, and supplies the outputted signal to the control section 29. In this manner, tilt correction according to the tilt quantity of the optical disk is carried out for the objective lens 13 by means of the tilt actuator 27 driven by the tilt actuator driver 24, and a tilt (inclination) component of the optical disk D is corrected, thereby enabling a stable reproducing process (or recording process).

With respect to the differential computation in the differential circuit 26, it is preferable that a value of a push-pull signal for use in disk reproduction is monitored from among the two push-pull signals P1, P2, and that, only when the push-pull signal is zero, a differential computation is carried out to output the tilt detection signal “s”. This is because an error component is the smallest in amount when the value of the push-pull signal is zero. In addition, it is also preferable that, only when the values of both of the push-pull signals P1, P2 are zero, a differential computation is carried out to output the tilt detection signal “s”.

Here, with respect to the tilt detection signal “s” from the differential circuit 26, a control signal from the control section 29 is supplied to the tilt actuator driver 24 via the control section 29, the control signal is received, and then, tilt correction is carried out on the basis of the control quantity of the objective lens 13 of the tilt actuator 27. However, at the same time, it is preferable that the tilt detection signal “s” from the differential circuit 26 is directly supplied to the tilt actuator driver 24 without being supplied via the control section 29, and that the tilt actuator driver 24 drives the tilt actuator in order to correct the objective lens in response to the tilt detection signal “s”, thereby carrying out a tilt correcting process.

Furthermore, in the above-described embodiment, the objective lens is tilted by the tilt actuator driver and the tilt actuator according to the detected tilt signal, thereby correcting a tilt of the disk, but the embodiment of the present invention is not limited thereto. For example, a pickup drive element is provided and an angle of a whole pickup PU is tilted according to the detected tilt signal, thereby making it possible to correct a tilt of the disk similarly. As in the above-described embodiment, precise tilt correction can be carried out without using a dedicated tilt detecting element.

(In the Case Where Three or More Laser Lights are Used)

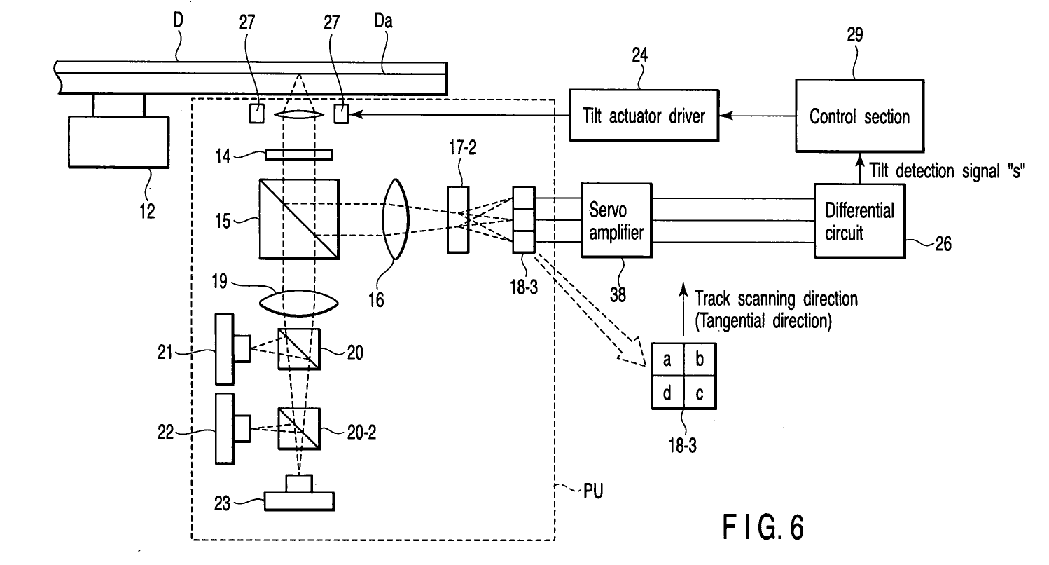

Furthermore, as shown in FIG. 6, a tilt correction process according to one embodiment of the invention can be carried out also in the case where three or more laser light sources 21, 22, 23 are used. That is, it is possible to further provide a second dichroic prism 20-2 and to ensure that the light source 21 (first wavelength), the light source 22 (second wavelength), and the light source 23 (third wavelength) having their difference wave are in proximity to 405 nm in the first wavelength (high density DVD), in proximity to 660 nm in the second wavelength (DVD), and in proximity to 785 nm in the third wavelength (CD), but the embodiment is not limited thereto. For example, it is preferable that the first laser light is equal to or smaller than 440 nm in wavelength, the second laser light is in the range of 660 nm to 700 nm in wavelength, and the third laser light is equal to or greater than 700 nm.

With respect to such three or more laser light sources 21, 22, 23, it is preferable that, for example, a hologram 17-2 having wavelength selectivity is utilized as a splitter section 17-2 to completely split three laser light sources into three sections according to their wavelengths, and that the lights are received at three different light receiving elements on a light receiver section 18-3 to output the detection signals, respectively.

Here, all the three laser light sources 21, 22, 23 may emit lights at the same time, and only two of the three laser light sources may emit lights, thereby computing a differential signal in response to a detection signal and outputting the tilt detection signal “s”. In addition, it is also preferable to carry out tilt correction by using a detection signal of a laser light source other than those used for reproduction.

As has been described above in detail, according to one embodiment of the invention, there can be provided an optical pickup device capable of carrying out tilt correction with high reliability having a tracking offset or the like eliminated only by utilizing the existing element without providing a dedicated tilt detection element or the like.

<Optical Disk Device>

Now, an example of an information recording and reproducing apparatus using the above-described optical pickup device involving tilt correction will be described by way of example of an optical disk device.

Basic Configuration

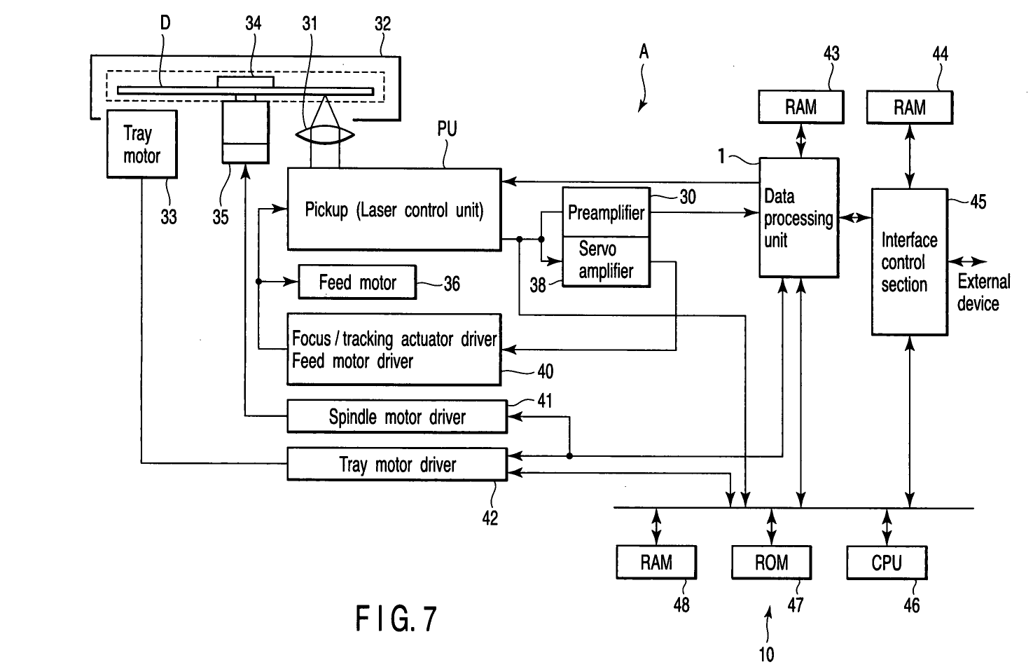

In FIG. 7, an optical disk device A using the optical pickup device according to the invention carries out data recording or data reproduction to or from an optical disk D. The optical disk device A has: a tray 32 which transports the optical disk D housed in a disk cartridge; a motor 33 which drives the tray; a clamper 34 which holds the optical disk D; and a spindle motor 12 which rotates the optical disk D held by the clamper in a predetermined rotation frequency. Further, a CPU 46, a ROM 47, and a RAM 48 are connected to the optical disk device A via a control bus. The CPU 46 makes a whole operation control as a control section. The ROM 47 stores therein a basic program or the like for the control operation. The RAM 48 stores a variety of control programs, application data and the like in a rewritable manner. A feed motor 36, a focus/tracking tilt actuator driver/feed motor driver 40, a spindle motor driver 41, and a tray motor driver 42 are further provided. The feed motor 36 is connected to the control sections such as the CPU 46 to transport a pickup PU. The focus/tracking tilt actuator driver/feed motor driver 40 makes pickup focusing or tracking control and tilt control. The spindle motor driver 41 drives the spindle motor 12. The tray motor driver 42 drives a tray motor.

Furthermore, the optical disk device has: a preamplifier 30 connected to the pickup head PU to amplify a detection signal; and a servo amplifier 38. The optical disk device also includes: a data processing unit 1 connected to the pickup head PU, the preamplifier 30 and the like, for processing a detection signal and a recording signal; and a RAM 43 for storing data for use in these various processes. An interface control section 45 is provided together with the RAM 44 in order to transmit and receive a signal from the data processing unit 1 to and from an external device.

Basic Operation

The thus configured optical disk device to which the optical pickup device according to the invention is applied carries out a reproducing process and a recording process for the optical disk, as described below. That is, when the optical disk D is mounted on the optical disk device A, control information contained in the optical disk D, the control information being recorded in a control data zone in an emboss data zone of a lead-in area of the optical disk D, is read by using the pickup head PU and the data processing unit 1, so as to be supplied to the CPU 46.

The optical disk device A to which the optical pickup device according to the invention is applied generates laser lights to be energized by the LD light sources 21 to 23 under the control of the CPU 46 on the basis of user operation information, the control information contained in the optical disk D, the control information being recorded in the control data zone in the optical disk, a current status and the like.

The generated laser lights are converged by the objective lens 13, and the converged lights are emitted to a recording region of the optical disk D. In this manner, data is recorded in the recording region of the optical disk D (the data is recorded in the optical disk D in accordance with generation of a mark row; an interval between marks each having a variable length; and a length of each of the marks having a variable length). Alternatively, light having intensity which corresponds to the stored data is reflected, the reflected light is detected, and the data is reproduced.

In addition, the optical disk D is transported to the inside of the device directly or by means of the tray 32 while the disk is housed in a disk cartridge such that the optical disk D is allocated to be opposed to the objective lens 13. A tray motor 33 for driving the tray 32 is provided in the device. The mounted optical disk D is held on the spindle motor 12 so as to be rotatable by the clamper 34, and is rotated by the spindle motor 12 in a predetermined rotation frequency.

The pickup head PU has an optical detector 18 which detects a laser light incorporated therein. The optical detector 18 detects a laser light reflected on the optical disk D and returned via the objective lens 13.

The detection signal is supplied to the preamplifier 30 and the servo amplifier 34. Signals for data reproduction of a header section and for data reproduction in a recording region are outputted to the data processing unit 1 from the preamplifier 30.

Here, although an astigmatic focus error detection method or the above-described knife edge focus error detection method are available for use as a method of optically detecting a focus deviation quantity, another focus control method can also be applied to the present invention similarly.

The optical disk D has a spirally shaped or concentrically shaped track, and information is recorded on the track. A focusing spot is traced along the track, and reproduction or recording/erasing of information is carried out. In order to stably trace the focusing spot along the track, it is necessary to optically detect a relative displacement between the track and the focusing spot. Thus, a tilt control, a tracking control, and a focus control are carried out by the tilt actuator driver 24, the focus/tracking actuator driver 40 and the like.

The spindle motor driver 41 and the trace motor driver 42 are controlled by a control signal from the data processing unit 1, the spindle motor 12 and the tray motor 33 are energized, and the spindle motor 12 is rotated in a predetermined rotation frequency. As a result, the tray motor 33 properly controls a tray.

A reproduction signal RF corresponding to data contained in the header section, the signal being supplied to the data processing unit, is supplied to the CPU 46. In this manner, the CPU 46 determines a sector number as an address of the header section by the reproduction signal RF and makes comparison with a sector number serving as an address to be accessed (where data is recorded, or recorded data is reproduced).

In addition, with respect to the reproduction signal RF corresponding to the data contained in the recording region, the signal being supplied to the data processing unit 1, the data required for the RAM 48 is stored, the reproduction signal RF is processed by the data processing unit 1, the processed signal is supplied to the interface control section 45, and, a reproduction processing signal is supplied to an external device such as, for example, a personal computer.

The above-described optical pickup device according to one embodiment of the invention is applied to such an optical disk device, thereby acquiring a differential signal between push-pull signals of detection signals of a plurality of laser light sources and acquiring a tilt detection signal “s” based on the detected signal. In this manner, there can be provided an optical pickup device capable of, by making a tilt control, carrying out tilt correction having high reliability in which a tracking offset or the like is eliminated only by utilizing the existing element without providing a dedicated tilt detection element or the like.

As has been described above, according to one embodiment of the present invention, an optical disk device is featured in that, a plurality of laser lights such as, for example, blue laser lights of a high density digital versatile disc (HD DVD) and DVD laser lights are emitted at the same time; reflection lights of the laser lights are received, respectively; detection signals are acquired; and a differential signal of the detection signals is obtained. Then, a tilt quantity is estimated according to the size of the differential signal, the objective lens is controlled to be positioned by the tilt actuator, and the tilt quantity is corrected. At this time, the tilt quantity is detected on the basis of the differential signal of the detection signals according to a plurality of laser lights, thereby eliminating the tracking offset or the like included in the detection signal. Thus, the detection signal is not influenced by this offset, a precise tilt quantity is detected, and a reliable tilt control is made, thereby making it possible to carry out a disk control with high reliability. In addition, a tilt control can be achieved by using only the existing element without providing a dedicated element for tilt detection.

In accordance with the above-described various embodiments, one skilled in the art can achieve the present invention. However, a variety of modified examples of these embodiments can be easily conceived by one skilled in the art and can be applied to a variety of embodiments even if one does not have any inventive ability. Therefore, the present invention covers a broad scope without departing from the disclosed principle and novel characteristics, and is not limited to the above-described embodiments.

What is claimed is:

1. An optical pickup device comprising:
a first emitting section which emits a first laser light;
a second emitting section which emits a second laser light that is different from the first laser light;
an objective lens which focuses the first and second laser lights emitted from the first and second emitting sections and emits the focused laser lights to an information storage medium;
a splitter section which receives reflection lights of the first and second laser lights from the information recording medium and splits the lights;
a light receiving section which receives the reflection lights of the first and second laser lights from the splitter section and outputs a detection signal in response to each of the reflection lights;
a differential calculating section which obtains a differential signal between detection signals according to the reflection lights from the light receiving section and outputs a tilt signal indicating a tilt of the information recording medium on the basis of the obtained differential signal; and
a correcting section which corrects a tilt of the information recording medium with respect to an emission direction of at least one of the first and second laser lights on the basis of the tilt signal outputted from the differential calculating section.

2. An optical pickup device according to claim 1, wherein the correcting section includes:
an actuator driver section which outputs a drive signal on the basis of the tilt signal from the differential calculating section; and
a tilt actuator section which corrects a tilt of the information recording medium by changing a tilt of the objective lens, on the basis of the drive signal from the actuator driver section.

3. An optical pickup device according to claim 1, wherein the differential calculating section obtains the differential signal between the detection signals according to the reflection lights of the first and second laser lights at a timing at which a push-pull signal generated on the basis of the detection signal outputted from the light receiving section is zero.

4. An optical pickup device according to claim 1, wherein the splitter section is a prism which selectively splits the first laser light and the second laser light according to a wavelength.

5. An optical pickup device according to claim 1, wherein the splitter section is a hologram which selectively carries out a wave face conversion for the first laser light and the second laser light according to a wavelength.

6. An optical pickup device according to claim 1, further having a third emitting section which emits a third laser light having a wavelength different from those of the first and second laser lights, wherein
the splitter section splits the first to third laser lights, and
the differential calculating section obtains a differential signal of detection signals according to the first to third laser lights from the light receiving section, and outputs a tilt signal indicating a tilt of the information recording medium on the basis of the differential signal.

7. An optical pickup device comprising:
a first emitting section which emits a first laser light;
a second emitting section which emits a second laser light that is different from the first laser light;
an objective lens which focuses the first and second laser lights emitted from the first and second emitting sections and emits the focused laser lights to an information storage medium;
a splitter section which receives reflection lights of the first and second laser lights from the information recording medium and splits the lights;
a light receiving section which receives the reflection lights of the first and second laser lights from the splitter section and outputs a detection signal in response to each of the reflection lights;
a differential calculating section which obtains a differential signal between detection signals according to the reflection lights from the light receiving section and outputs a tilt signal indicating a tilt of the information recording medium on the basis of the obtained differential signal;
a correcting section which corrects a tilt of the information recording medium with respect to an emission direction of at least one of the first and second laser lights on the basis of the tilt signal outputted from the differential calculating section; and
a processing section which carries out a recording process or a reproducing process for the information recording medium on the basis of the detection signal received by the light receiving section.

8. An optical pickup device according to claim 7, wherein the correcting section includes:
an actuator driver section which outputs a drive signal on the basis of the tilt signal from the differential calculating section; and
a tilt actuator section which corrects a tilt of the information recording medium by changing a tilt of the objective lens, on the basis of the drive signal from the actuator driver section.

9. An optical pickup device according to claim 7, wherein the differential calculating section obtains the differential signal between the detection signals according to the reflection lights of the first and second laser lights at a timing at which a push-pull signal generated on the basis of the detection signal outputted from the light receiving section is zero.

10. An optical pickup device according to claim 7, wherein the splitter section is a prism which selectively splits the first laser light and the second laser light according to a wavelength.

11. An optical pickup device according to claim 7, wherein the splitter section is a hologram which selectively carries out a wave face conversion for the first laser light and the second laser light according to a wavelength.

12. An optical pickup device according to claim 7, further having a third emitting section which emits a third laser light having a wavelength different from those of the first and second laser lights, wherein
the splitter section splits the first to third laser lights; and
the differential calculating section obtains a differential signal of detection signals according to the first to third laser lights from the light receiving section, and outputs a tilt signal indicating a tilt of the information recording medium on the basis of the differential signal.
